(19) United States
(12) Patent Application Publication
(10) Pub. No.: US 2024/0381396 A1
(43) Pub. Date: Nov. 14, 2024

(54) METHOD AND APPARATUS FOR HANDLING COMMUNICATION SUPPORT INFORMATION OF UNCREWED AERIAL VEHICLE (UAV) IN WIRELESS WIRELESS COMMUNICATION SYSTEM

(71) Applicant: SAMSUNG ELECTRONICS CO., LTD., Suwon-si (KR)

(72) Inventors: Hyunjeong KANG, Suwon-si (KR); Sangyeob JUNG, Suwon-si (KR)

(21) Appl. No.: 18/660,045

(22) Filed: May 9, 2024

(30) Foreign Application Priority Data
May 11, 2023 (KR) 10-2023-0061134

(51) Int. Cl. H04W 72/40; H04W 72/23; H04W 92/18

(52) U.S. Cl. CPC H04W 72/40; H04W 72/23; H04W 92/18

(57) ABSTRACT

The disclosure relates to a 5G or 6G communication system for supporting higher data rates. A method, for transmitting at least one of the UAV service message and the UAM service message using a PC5-based terminal-to-terminal direct communication scheme, performed by a terminal includes: determining whether a serving cell supports A2X communication, determining whether the service cell provides a SIB message including sidelink configuration information on the A2X communication, determining whether the serving cell provides a SIB message including a sidelink transmission resource configuration on the A2X communication, determining a sidelink transmission resource allocation mode for the A2X communication for transmitting at least one of the UAV service message and the UAM service message using the PC5-based terminal-to-terminal direct communication scheme, and determining sidelink radio bearer configuration for the A2X communication.

### CROSS REFERENCE TO RELATED APPLICATION

The present application claims priority under 35 U.S.C. § 119 to Korean Patent Application No. 10-2023-0061134, filed on May 11, 2023, in the Korean Intellectual Property Office, the entire contents of which is incorporated herein for all purposes by this reference.

### BACKGROUND

### 1. Field

The disclosure relates to a method and apparatus for determining whether the serving cell of a terminal supports aerial to everything (A2X) communication through a PC5 interface when an unmanned aerial vehicle terminal transmits and receives an A2X communication-based service messages through the PC5 interface in a wireless communication system.

### 2. Description of the Related Art

5th generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting various numerologies (for example, operating a plurality of subcarrier spacings, etc.) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large scale antennas, metamaterial-based lenses and antennas for improving coverage of terahertz band signals, high-dimensional space multiplexing technology using orbital angular momentum (OAM), and reconfigurable intelligent surface (RIS), but also full duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of terminal operation capability by utilizing ultra-high-performance communication and computing resources.

Research into terminal-to-terminal direct communication (sidelink communication) using a 5G communication system has been conducted, and it is expected that the sidelink communication is applicable to, for example, vehicle-to-everything (hereinafter, referred to as “V2X”) communication, a public safety network, and drone communication, and can thus provide various services to a user. As an example, drone communication can be supported by A2X communication, which can transmit and receive service messages of an unmanned mobile aircraft through the terminal-to-terminal direct communication scheme.

### SUMMARY

An object of the disclosure is to provide a method and apparatus for processing information that can determine whether a serving cell supports A2X communication in a wireless communication system supporting an unmanned mobile aircraft.

The technical objects to be achieved by the disclosure are not limited to the technical objects mentioned above, and other technical objects not mentioned may be clearly understood by those skilled in the art from the following descriptions.

In order to solve the above problem, a method performed by a terminal in a wireless communication system according to an embodiment of the disclosure may include determining whether a serving cell supports AX communication which may transmit and receive at least one of a UAV service message and a UAM service message using a PC5-based terminal-to-terminal direct communication scheme, determining whether the service cell supports a mode in which a base station allocates transmission resources in A2X communication which may transmit and receive at least one of the UAV service message and the UAM service message using the PC5-based terminal-to-terminal direct communication scheme, determining whether the serving cell provides a SIB message including sidelink configuration information to be used in the A2X communication which may transmit and receive at least one of the UAV service message and the UAM service message using the PC5-based terminal-to-terminal direct communication scheme, determining whether the serving cell provides sidelink transmission resources to be used in the A2X communication that may transmit and receive at least one of the UAV service message and the UAM service message using the PC5-based terminal-to-terminal direct communication scheme through the SIB message.

Further, a method performed by a terminal in a wireless communication system according to an embodiment of the disclosure, may comprise receiving, from a base station, a message including first information on a resource to perform sidelink communication; identifying whether the message further includes second information on a resource pool to perform an aircraft to everything (A2X) communication; and in case that the message further includes the second information, performing the A2X communication with another terminal using at least one resource indicated by the second information, wherein the terminal may be configured to perform the A2X communication for an A2X service.

Still further, a method performed by a base station in a wireless communication system according to an embodiment of the disclosure may comprise generating first information on a resource to perform sidelink communication and second information on a resource pool to perform an aircraft to everything (A2X) communication; and transmitting, to a terminal, a message including the first information and the second information, wherein the terminal may be configured to perform the A2X communication for an A2X service, and wherein at least one resource indicated by the second information may be used for performing the A2X communication between the terminal and another terminal.

Still further, a terminal in a wireless communication system according to an embodiment of the disclosure may comprise a transceiver; and a controller configured to control the transceiver to receive, from a base station, a message including first information on a resource to perform sidelink communication, identify whether the message further includes second information on a resource pool to perform an aircraft to everything (A2X) communication, and in case that the message further includes the second information, perform the A2X communication with another terminal using at least one resource indicated by the second information, wherein the terminal may be configured to perform the A2X communication for an A2X service.

Still further, a base station in a wireless communication system according to an embodiment of the disclosure may comprise a transceiver; and a controller configured to generate first information on a resource to perform sidelink communication and second information on a resource pool to perform an aircraft to everything (A2X) communication, and control the transceiver to transmit, to a terminal, a message including the first information and the second information, wherein the terminal is configured to perform the A2X communication for an A2X service, and wherein at least one resource indicated by the second information may be used for performing the A2X communication between the terminal and another terminal.

According to an embodiment of the disclosure, there is an effect of providing safe drone communication or urban air mobility communication in a wireless communication system.

The effects that can be obtained from the disclosure are not limited to the effects mentioned above, and other effects not mentioned will be clearly understood by those skilled in the art from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a scenario supporting an unmanned vehicle service message in a wireless communication system according to an embodiment of the present disclosure;

FIG. 2 illustrates a scenario supporting an unmanned vehicle service message in a wireless communication system according to an embodiment of the present disclosure;

FIG. 3 illustrates a signaling flow between a terminal and a base station that processes A2X communication support information in a wireless communication system according to an embodiment of the present disclosure;

FIG. 4 illustrates a signaling flow between a terminal and a base station that processes A2X communication configuration information in a wireless communication system according to an embodiment of the present disclosure;

FIG. 5 illustrates a signaling flow between a terminal and a base station that processes A2X communication transmission resources in a wireless communication system according to an embodiment of the present disclosure;

FIG. 6 illustrates an operation of a terminal that processes an A2X communication transmission resource allocation mode in a wireless communication system according to an embodiment of the present disclosure;

FIG. 7 illustrates an operation of a terminal that processes A2X communication radio bearer configuration in a wireless communication system according to an embodiment of the present disclosure;

FIG. 8 illustrates a structure of a terminal according to an embodiment of the present disclosure; and

FIG. 9 illustrates a structure of a base station according to an embodiment of the present disclosure.

### DETAILED DESCRIPTION

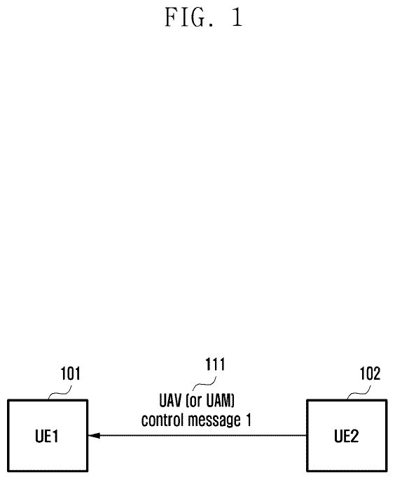

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, preferred embodiments of the disclosure will be described in detail with reference to the accompanying drawings. In this case, it should be noted that in the accompanying drawings, the same components are denoted by the same reference numerals as much as possible. In addition, detailed descriptions of well-known functions and configurations that may obscure the gist of the disclosure will be omitted.

In describing the embodiments of the specification, descriptions of technical contents that are well known in the technical field to which the disclosure belongs and are not directly related to the disclosure will be omitted. This is to more clearly convey the gist of the disclosure by omitting unnecessary description.

For the same reason, some components are exaggerated, omitted, or schematically illustrated in the accompanying drawings. In addition, the size of each component does not fully reflect the actual size. In each figure, the same or corresponding elements are assigned the same reference numerals.

Advantages and features of the disclosure and methods of accomplishing the same may be understood more readily by with reference to the following detailed description of the embodiments of the disclosure and the accompanying drawings. The disclosure may, however, be embodied in many different forms and should not be construed as limited to embodiments set forth herein; rather these embodiments are provided so that this disclosure will be thorough and complete, and will fully convey the scope of the disclosure only defined by the claims to one of ordinary skill in the art. The same reference numerals refer to the same elements throughout the disclosure.

In this case, it will be understood that each block of process flowcharts and combinations of the flowcharts may be performed by computer program instructions. Because these computer program instructions may be embedded in a processor of a general-purpose computer, a special-purpose computer, or other programmable data processing apparatuses, the instructions executed through the processor of the computer or other programmable data processing apparatus generates means for performing the functions described in the flowchart block(s). Because these computer program instructions may also be stored in a computer-executable or computer-readable memory that may direct the computer or other programmable data processing apparatus so as to implement functions in a particular manner, the instructions stored in the computer-executable or computer-readable memory are also capable of producing an article of manufacture containing instruction modules for performing the functions described in the flowchart block(s). Because the computer program instructions may also be embedded into the computer or other programmable data processing apparatus, the instructions for executing the computer or other programmable data processing apparatuses by generating a computer-implemented process by performing a series of operations on the computer or other programmable data processing apparatuses may provide operations for executing the functions described in the flowchart block(s).

Also, each block may represent part of a module, segment, or code that includes one or more executable instructions for executing a specified logical function(s). It should also be noted that, in some alternative implementations, the functions described in the blocks may occur out of the order noted in the drawings. For example, two blocks illustrated in succession may in fact be executed substantially concurrently, or the blocks may sometimes be executed in a reverse order, depending on the corresponding functions involved therein.

In this case, as used herein, the “unit” refers to a software element or a hardware element, such as FPGA or ASIC, which performs a predetermined function. However, the “unit” does not always have a meaning limited to software or hardware. The “unit” may be constructed either to be stored in an addressable storage medium or to execute one or more processors. Thus, a “unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the components and “units” may be combined into fewer components and “units” or may be further separated into additional components and “units.” Further, the components and “units” may be implemented to operate one or more CPUs in a device or a secure multimedia card.

The detailed description of embodiments of the disclosure is made mainly on the basis of a new radio (NR) access network and packet core (a 5G system, a 5G core network, or a next generation (NG) core) which is a core network on the 5G mobile communication standard specified by the 3GPP, which is a mobile communication standardization organization, but the main subject of the disclosure can be applied to other communication systems having a similar technical background with slight modification without departing from the scope of the disclosure, which can be determined by those skilled in the art.

In the 5G system, a network data collection and analysis function (NWDAF) that is a network function for analyzing and providing data collected by a 5G network may be defined to support network automation. The NWDAF may collect information from the 5G network, store and analyze the information, and provide the result to an unspecified network function (NF), and the analysis result may be independently used by each NF.

For convenience of explanation, the disclosure will hereinafter use terms and names defined by the 3rd generation partnership project long term evolution (3GPP) standards (standards of 5G, NR, LTE, or similar systems). However, the disclosure is not limited by the terms and names and may be equally applied to systems conforming to other standards.

In the following description, terms with reference to a signal, terms with reference to a channel, terms with reference to control information, terms with reference to network entities, and terms with reference to elements of a device are used for convenience of description. Accordingly, the disclosure is not limited to those terms, and other terms having the same technical meanings may be used.

Hereinafter, a base station refers to an entity for allocating resources to a terminal and may be at least one of a gNode B, an eNode B, a node B, a base station (BS), a radio access unit, a base station controller, and a node over a network. A terminal may include a user equipment (UE), a mobile station (MS), a cellular phone, a smartphone, a computer, or a multimedia system capable of performing a communication function. However, this is only an example, and the base station and terminal are not limited to the examples described above. In the disclosure, an eNB may be interchangeably used with a gNB for convenience of descriptions. That is, a BS described by an eNB may represent a gNB. In the disclosure, the term “terminals” may refer to not only cellular phones, NB-IoT devices, and sensors, but also various wireless communication devices.

In the following description, the terms of physical channel and signal may be interchangeably used with data or a control signal. For example, a physical downlink shared channel (PDSCH) is a term with reference to a physical channel on which data is transmitted. However, the PDSCH may also be used to refer to data. In other words, in the disclosure, the expression “transmit a physical channel” may be interpreted as being equivalent to the expression “transmit data or a signal on a physical channel.”

Hereinafter, in the disclosure, higher layer signaling denotes a signal transfer scheme in which a signal is transferred to a terminal from a base station by using a downlink data channel at a physical layer, or in which a signal is transferred to a base station from a terminal by using an uplink data channel at a physical layer. The higher layer signaling may be understood as radio resource control (RRC) signaling or a media access control (MAC) control element (CE).

In addition, in the disclosure, to determine whether a specific condition is satisfied or fulfilled, the expression of exceeding or less than has been used, but this is merely an example, and does not exclude a statement of equal to or more than or equal to or less than. A condition stated as “equal to or more than” may be replaced with “exceeding,” and a condition stated as “equal to or less than” may be replaced with “less than,” and a condition stated “as equal to or more than and less than” may be replaced with “exceeding and equal to or less than.”

In addition, the disclosure describes an embodiment by using terms used in some communication standards (e.g., a 3rd generation partnership project (3GPP)), but this is merely an example. An embodiment of the disclosure may easily be modified and applied to other communication systems.

In addition, research into terminal-to-terminal direct communication (sidelink communication) using a 5G communication system has been conducted, and it is expected that the terminal-to-terminal direct communication is applicable to, for example, vehicle-to-everything (hereinafter, referred to as “V2X”) communication, a public safety network, and drone communication, and can thus provide various services to a user.

An embodiment of the disclosure provides a method and apparatus for processing, in a serving cell of a wireless communication system supporting an unmanned mobile aircraft, information on determining whether A2X communication using a PC5 interface for transmitting and receiving service messages of an unmanned mobile aircraft is supported, sidelink configuration information required to perform A2X communication, a system information block (SIB) message including sidelink transmission resource information, sidelink transmission resource allocation mode required to perform A2X communication, and sidelink radio bearer configuration. The service message of the unmanned mobile aircraft may include, for example, at least one of information for identifying the unmanned mobile aircraft and control information for controlling the unmanned mobile aircraft, or a combination thereof.

According to an embodiment of the disclosure, safe drone communication and urban air mobility communication may be provided by synchronizing wireless transmission profiles between terminals that exchange service messages of an unmanned mobile aircraft in a wireless communication system.

The disclosure may provide a method and apparatus using a terminal-to-terminal direct communication interface (e.g., PC5, sidelink) in order to control an unmanned aerial vehicle (UAV) (e.g., drone) in a wireless communication system, or an aerial vehicle without a pilot or with limited pilot involvement (e.g., urban air mobility (UAM)). In the disclosure, a scenario in which a terminal-to-terminal direct communication interface is used may include a procedure for obtaining UAV identification information or UAM identification information of an unmanned aerial vehicle or urban air mobility from an agency (for example, an agency responsible for law enforcement, such as the U.S. Federal Aviation Administration) that regulates unmanned aerial vehicles or urban air mobilities. The terminals mounted on unmanned aerial vehicles in accordance with regulatory policies may transmit UAV identification information to the terminals managed by regulatory agencies.

According to an embodiment, the terminal may transmit UAV identification information or UAM identification information through a terminal-to-terminal direct communication interface. In the disclosure, in addition to messages including UAV identification information or UAM identification information, messages including information necessary to control an unmanned aerial vehicle or urban air mobility may be defined as UAV control messages. It is apparent that the messages are not limited to the above example, and UAV control messages may further include various messages.

The terminal mounted on an unmanned aerial vehicle, a terminal mounted on an urban air mobility, or a terminal managed by a regulatory agency (Law Enforcement) may transmit, receive, and process a UAV control message including required control information through a terminal-to-terminal direct communication interface. Examples of scenarios which use UAV control messages and may be operated according to various embodiments of the disclosure may include terminal identifier broadcast control, collision detection, and collision avoidance control as shown in [Table 1] below, but are not limited thereto.

TABLE 1
Use of A2X (aerial to everything or aircraft to everything) for BRID
(broadcast remote identification):
the content of the messages for BRID are defined according to the
regional regulations for BRID (e.g., message set of ASTM F3411.19 or ASD-STAN
prEN 4709-002 P1) and optionally according to regional mean of compliance
documents.
Use of A2X (aerial to everything or aircraft to everything) for DAA
(detect and avoid):
the content of the messages for DAA are defined according to the regional
regulations for DAA and is out of scope of this specification.

According to various embodiments of the disclosure, the UAV control message may include remote a UE identification (which is used when remotely transmitting the terminal identifier of an unmanned mobile vehicle), a remote UE identification request (which is used when remotely requesting transmission of the terminal identifier of an unmanned mobile vehicle), remote UE positioning information (which is used when remotely transmitting location information of an unmanned vehicle), a remote UE positioning request (which is used when remotely requesting location information of an unmanned vehicle), remote UE path information (which is used when remotely transmitting the navigation path of an unmanned vehicle), a remote UE path request (which is used when remotely requesting the navigation path of an unmanned vehicle), and detect and avoid (DAA) control (which is used to notify that a collision of an unmanned vehicle has been detected or to instruct to avoid a collision), etc., and the UAV control message may be transmitted through a PC5 interface.

As an embodiment, an unmanned vehicle service message including the terminal identifier of an unmanned vehicle, that is, a remote UE identification, may be defined as shown in [Table 2] below, but is not limited thereto.

TABLE 2

The terminal identifier message specification of
an unmanned vehicle my include the following.
Message set of ASTM F3411.19
ASD-STAN prEN 4709-002 P1
Information included in the terminal identifier
message specification of an unmanned vehicle
may include the following.
Standard remote identification: UA, ID, UA
location/longitude/altitude/speed, CS
location/longitude/altitude, emergency situation
and time mark
Remote identification broadcast module: Module
serial number, UA location/longitude/altitude/
speed, takeoff site location/longitude/altitude,
Time Mark
UAS operator registration number, UA unique
serial number, Time Mark, pilot location or
takeoff site location, emergency situation
information

The unmanned vehicles used in the disclosure may include both an unmanned aerial vehicle and urban air mobility. It is apparent that the unmanned vehicles are not limited to the examples, and unmanned vehicles may include all types of vehicles without people on board, other than unmanned aerial vehicles and urban air mobility.

A method performed by a terminal in a wireless communication system may include determining whether transmission or reception of a UAV (drone) service message or UAM (urban air mobility) service message is authorized to be performed using PC5 interface-based A2X communication, determining a transmission (TX) profile mapped to transmit or receive a service message using the PC5 interface-based A2X communication, determining a wireless transmission parameter corresponding to the TX profile, transmitting or receiving using the wireless transmission parameter corresponding to the TX profile, and transmitting a destination layer-2 identifier mapped to the service identifier of a service message, PC5 radio access technology (RAT) information mapped to the destination layer-2 identifier, and TX profile information mapped to the PC5 RAT information from the upper layer of the terminal to the AS (access stratum) layer of the terminal.

FIG. 1 illustrates a scenario supporting an unmanned vehicle service message in a wireless communication system according to an embodiment of the present disclosure.

With reference to FIG. 1, a UE 1 101 and a UE 2 102 may be terminals of a wireless communication system supporting unmanned vehicles. As an example, the UE 1 101 may correspond to a terminal managed by an organization that regulates unmanned vehicles. The UE 2 102 may correspond to the terminal mounted on an unmanned vehicle. As another example, both the UE 1 101 and the UE 2 102 may correspond to the terminals mounted on an unmanned vehicle. The UE 2 102 may broadcast a UAV control message 1 or a UAM control message 1 110 to the UE 1 101 through a direct communication interface (e.g., PC5, sidelink) (or groupcast transmission or one-way unicast transmission).

Based on FIG. 1, an example scenario in which the UE 1 101 and the UE 2 102 transmit and receive unmanned vehicle control signaling is as follows.

The UE 2 102 may transmit its own identification information to the UE 1 101 using a direct communication interface (e.g., PC5, sidelink) so that it may identify information (authentication information, user registration information, etc.) on the unmanned vehicle in operation. The UE 1 101 may be a terminal that manages unmanned vehicles (for example, a terminal managed by an organization that regulates unmanned vehicles). The UE 2 102 may be the terminal mounted on an unmanned vehicle. For example, the identification information of the UE 2 102 may be included in UAV control message 1 or UAM control message 1 110 transmitted from the UE 2 102 to the UE 1 101.

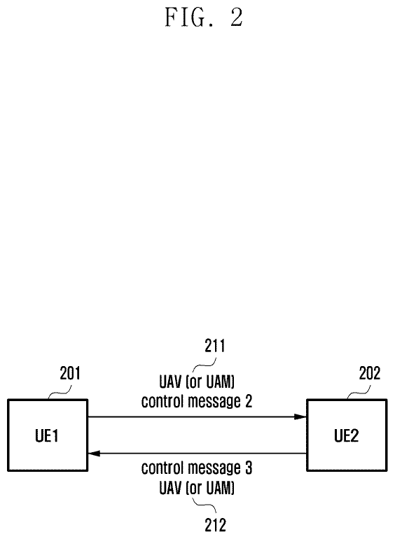

FIG. 2 illustrates a scenario supporting an unmanned vehicle service message in a wireless communication system according to an embodiment of the present disclosure.

With reference to FIG. 2, the UE 1 201 and the UE 2 202 may be terminals of a wireless communication system supporting unmanned vehicles. As an example, the UE 1 201 may correspond to a terminal managed by an organization that regulates unmanned mobile vehicles. The UE 2 202 may correspond to the terminal mounted on an unmanned vehicle. As another example, the UE 1 201 and the UE 2 202 may correspond to the terminals mounted on an unmanned vehicle.

According to an embodiment of the disclosure, the UE 1 201 and the UE 2 202 may broadcast a UAV control message (or groupcast transmission or one-way/bidirectional unicast transmission) through a direct communication interface (e.g., PC5, sidelink).

Based on FIG. 2, an example scenario in which the UE 1 201 and the UE 2 202 transmit and receive unmanned vehicle control signaling is as follows.

The UE 1 201, which is managed by the agency that regulates unmanned vehicles, may transmit the UAV (or UAM) control message 2 210 requesting to transmit identification information to the UE 2 202 mounted on an unmanned vehicle by using a direct communication interface (e.g., PC5, sidelink) so that the agency that regulates unmanned vehicles may identify information (authentication information, user registration information, etc.) on the unmanned vehicle in operation. The UE 2 202 may transmit UAV (or UAM) control message 3 220 including its own identification information to the UE 1 201 using a direct communication interface.

In addition, according to an example of the disclosure, at least one of UAV control message 2 210 and UAV control message 3 220 or a combination thereof may be transmitted and received between the UE 1 201 and the UE 2 202 to request flight suspension or provide information on permitted flight sections.

According to the embodiments of FIGS. 1 and 2, in case that both the UE 1 101, 201 and the UE 2 102, 202 are the terminals mounted on an unmanned vehicle, the UAV control message transmitted and received by the UE 1 and the UE 2 may correspond to signaling including the UE's movement path, location (e.g., 3D location information), etc., or signaling to establish a direct communication connection and establish a direct communication connection session to exchange messages including the UE's movement path and location (e.g., 3D location information), etc.

In case that the UE 1 and the UE 2 according to the embodiments of FIGS. 1 and 2 transmit and receive the UAV control message using the PC5 interface-based A2X communication, the PC5 interface may correspond to a long term evolution (LTE) radio access technology (RAT)-based PC5 interface or new radio (NR) RAT-based PC5 interface. Therefore, the UE 1 and the UE 2 may know information on whether the UAV control messages may be transmitted and received using the PC5 interface-based A2X communication, and information on whether the UAV control message may be transmitted and received using an LTE RAT-based PC5 interface or NR RAT-based PC5 interface when the UAV control message may be transmitted and received using the PC5 interface-based A2X communication. This information may be defined as a TX profile, that is, a wireless transmission profile, that may be applied to transmitting and receiving the UAV control message to the UE 1 and the U 2 using the A2X communication.

As an embodiment of the disclosure, the policy shown in [Table 3] below may be configured to the UE in order for the U to transmit or receive the UAM service message or UAV service message using the PC5 interface-based A2X communication. However, the policy is not limited thereto.

TABLE 3
PC5 RAT: An indication of whether the PC5 interface of A2X communication is an
LTE RAT or NR RAT, or whether both RATs may be used.
Cast type: Unicast, group cast, broadcast indication (for example, a service message
including the UE identifier of an unmanned vehicle may be indicated to be transmitted
via a broadcast)
Frequency: Frequency designated to transmit and receive a UAV service message or
UAM service message based on A2X communication
RAT selection: LTE PC5 “served (or not served) by E-UTRA” or NR PC5 “served (or
not served) by NR” or LTE PC5/NR PC5 “served by E-UTRA or served by NR” or LTE
PC5/NR PC5 “not served by E-UTRA and not served by NR”
(Indicate whether LTE PC5 interface-based A2X communication may be serviced in an
E-UTRA network, whether NR PC5 interface-based A2X communication may be
serviced in an NR network, whether LTE PC5 interface-based A2X communication
may be serviced in an E-UTRA network or NR network, whether an NR PC5 interface-
based A2X communication may be served in both an E-UTRA network or NR network,
whether an LTE PC5 interface-based A2X communication may be serviced in both an
E-UTRA network and an NR network, whether an NR PC5 interface-based A2X
communication may be serviced in both an E-UTRA network and an NR network,
whether LTE PC5 interface-based A2X communication may not be served in both an
E-UTRA network and an NR network, or whether NR PC5 interface-based A2X
communication may not be serviced in both an E-UTRA network and an NR network)
Geographical area, altitude limitation, validity timer: Area information allowed for the
UE to perform A2X communication, indicating a permitted or restricted location in
terms of longitude, latitude, and altitude, or validity time for area information indicated
as permitted or restricted.
A2X service identifier: ITS-AID (ITS application identifier), PSID (Provider Service
Identifier), AID (Application Identifier) according to the values for aviation
applications (identification information of an A2X service message)
PLMN: PLMN information through which the UE may perform A2X communication

In case that the UE transmits and receives A2X communication service messages with another UE through a PC5-based UE-to-UE direct communication scheme, the UE may use sidelink transmission and reception resources for A2X communication provided by a serving cell, or use a sidelink configuration for A2X communication provided by the serving cell, or use a sidelink transmission resource for A2X communication allocated by the serving cell, or use a sidelink radio bearer for A2X communication configured by the serving cell. In this case, the UE may need to determine whether the serving cell supports A2X communication performed through the PC5-based UE-to-UE direct communication scheme. In case that the serving cell supports the A2X communication performed through the PC5-based UE-to-UE direct communication scheme, the UE may need to determine whether configuration information, transmission resource information, etc. required for the A2X communication performed through the PC5-based UE-to-UE direct communication scheme is obtained from a system information block (SIB) message provided by the serving cell.

In addition, in the A2X communication performed through the PC5-based UE-to-UE direct communication scheme, the UE needs to determine whether a transmission resource allocation mode is a mode in which a base station allocates transmission resources or a mode in which the UE directly allocates transmission resources. In addition, the UE may need to process sidelink radio bearer configuration to be used in the A2X communication performed through the PC5-based UE-to-UE direct communication scheme.

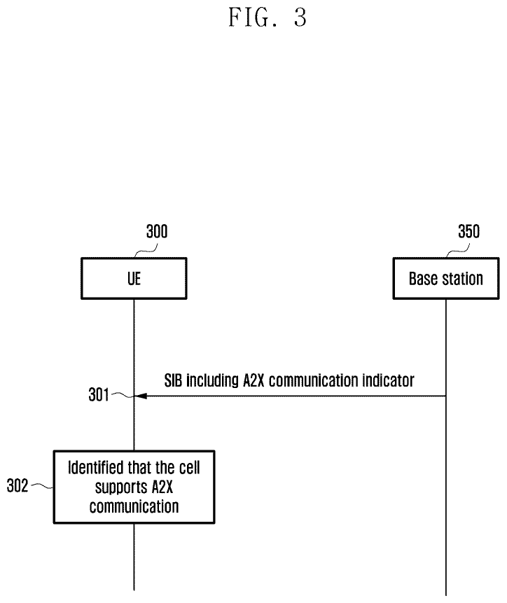

Hereinafter, with reference to FIGS. 3 to 7, the operations of the UE and base station that process information required for the A2X communication performed through the PC5-based UE-to-UE direct communication scheme will be described.

FIG. 3 illustrates a signaling flow between a UE and base station that processes A2X communication support information in a wireless communication system according to an embodiment of the present disclosure.

With reference to FIG. 3, a UE 300 is authenticated to transmit and receive A2X service messages using A2X communication using a UE-to-UE direct communication scheme. The UE 300 may receive the SIB message transmitted by a base station 350 and obtain information indicating whether the base station 350 supports A2X communication. Here, the base station 350 may include a serving cell of the UE. Information indicating whether the base station 350 supports A2X communication may be included in the SIB message transmitted by the base station 350. [Table 4] below describes an example of information included in the SIB message indicating whether the base station 350 supports A2X communication.

If the UE 300 obtains a SIB message (including an embodiment in [Table 4]) including information indicating whether the base station 350 supports A2X communication in operation 301, the UE 300 may determine that the base station 350 supports A2X communication in operation 302.

TABLE 4
Scheme 1: A new SIB message (e.g., SIB_A2X) may be used as information indicating
whether the base station supports A2X communication. This new SIB message is a SIB
message defined for A2X communication and may include configuration information,
resource allocation information, etc. that may be used in A2X communication. In case
that the base station may support A2X communication, the base station may transmit
this SIB message. If the UE obtains this SIB message, it may determine that the base
station may support A2X communication.
The SIB_A2X message may have the SIB message format defined in LTE in case that
LTE RAT-based A2X communication is supported. The SIB_A2X message may have
the SIB message format defined in NR when NR RAT-based A2X communication is
supported. An example of the SIB_A2X message format may include [Table 5].
Scheme 2: Indication information indicating whether the base station supports A2X
communication may be transmitted by including the indication information in the SIB
message. This SIB message may include at least one or a combination of SIB messages
defined for LTE PC5 communication or NR PC5 communication. The SIB messages
defined for LTE PC5 communication may include SIB21, SIB26, and SIB13 and SIB14
corresponding to respective ones. The SIB message defined for NR PC5 communication
may include SIB12. In case that the base station may support LTE RAT-based A2X
communication, the base station may include indication information indicating that
A2X communication is supported in at least one or combination of SIB messages
defined for LTE PC5 communication and transmit the same. In case that the base station
may support NR RAT-based A2X communication, the base station may include
indication information indicating that A2X communication is supported in at least one
or combination of SIB messages defined for NR PC5 communication and transmit the
same. If the UE obtains the SIB message defined for LTE PC5 communication that
includes the indication information indicating that A2X communication is supported,
the UE may determine that the base station may support LTE RAT-based A2X
communication. If the UE obtains the SIB message defined for NR PC5 communication
that includes the indication information indicating that A2X communication is
supported, the UE may determine that the base station may support NR RAT-based A2X
communication. Examples of indication information indicating that the base station
supports A2X communication that may be included in the SIB message defined for LTE
PC5 communication and SIB message defined for NR PC5 communication may include
the following.
Sl-A2X-Communication ENUMERATED {enabled}, OPTIONAL
Scheme 3: Indication information indicating whether the base station supports A2X
communication may be included in the SIB message and transmitted. This SIB message
may include a SIB 1 message. In case that the base station may support LTE RAT-based
A2X communication, the base station may include indication information indicating
that A2X communication is supported in the SIB 1 message in LTE format, and transmit
the same. In case that the base station may support NR RAT-based A2X communication,
the base station may include indication information indicating that A2X communication
is supported in the SIB1 message in NR format, and transmit the same. If the UE obtains
the SIB1 message in LTE format including the indication information indicating that
A2X communication is supported, the UE may determine that the base station may
support LTE RAT-based A2X communication. If the UE obtains the SIB1 message in
NR format including the indication information indicating that A2X communication is
supported, the UE may determine that the base station may support NR RAT-based A2X
communication. Examples of indication information indicating that the base station
supports A2X communication that may be included in the SIB1 message may include
the following.
sl-A2X-Communication ENUMERATED {enabled}, OPTIONAL

TABLE 5

```
SIB_A2X ::=  SEQUENCE {
  segmentNumber INTEGER (0..63),
  segmentType  ENUMERATED {notLastSegment, lastSegment},
  segmentContainer OCTET STRING
}
SIB_A2X-Ies ::=  SEQUENCE {
  sl-A2X-Communication ENUMERATED {enabled}, OPTIONAL,
  sl-ConfigCommon SL-ConfigCommon,
  lateNonCriticalExtension OCTET STRING OPTIONAL,
  ...,
}
SL-ConfigCommon ::= SEQUENCE {
  sl-FreqInfoList  SEQUENCE (SIZE (1..maxofFreqSL)) OF SL-
FreqConfigCommon OPTIONAL, -- Need R
  sl-UE-SelectedConfig SL-UE-SelectedConfig OPTIONAL, -- Need R
  sl-NR-AnchorCarrierFreqList SL-NR-AnchorCarrierFreqList OPTIONAL, -- Need
R
  sl-EUTRA-AnchorCarrierFreqList SL-EUTRA-AnchorCarrierFreqList OPTIONAL,
-- Need R
  sl-RadioBearerConfigList  SEQUENCE (SIZE (1..maxofSLRB)) OF SL-
RadioBearerConfig OPTIONAL, -- Need R
  sl-OffsetDFN  INTEGER (1..1000)  OPTIONAL, -- Need R
  sl-SSB-Priority  INTEGER (1..8)  OPTIONAL -- Need R
}
SL-NR-AnchorCarrierFreqList-r16 ::= SEQUENCE (SIZE (1..maxFreqSL-NR-r16))
OF ARFCN-ValueNR
SL-EUTRA-AnchorCarrierFreqList-r16 ::= SEQUENCE (SIZE (1..maxFreqSL-
EUTRA-r16)) OF ARFCN-ValueEUTRA
The sl-FreqInfoList indicates the A2X communication configuration on (some) carrier
frequency (ies).
The sl-EUTRA-AnchorCarrierFreqList indicates the EUTRA anchor carrier frequency
list, which can provide the NR based A2X communication configurations.
The sl-NR-AnchorCarrierFreqList indicates the NR anchor carrier frequency list, which
can provide the NR based A2X communication configurations.
The sl-A2X-Communication indicates the support of A2X communication.
```

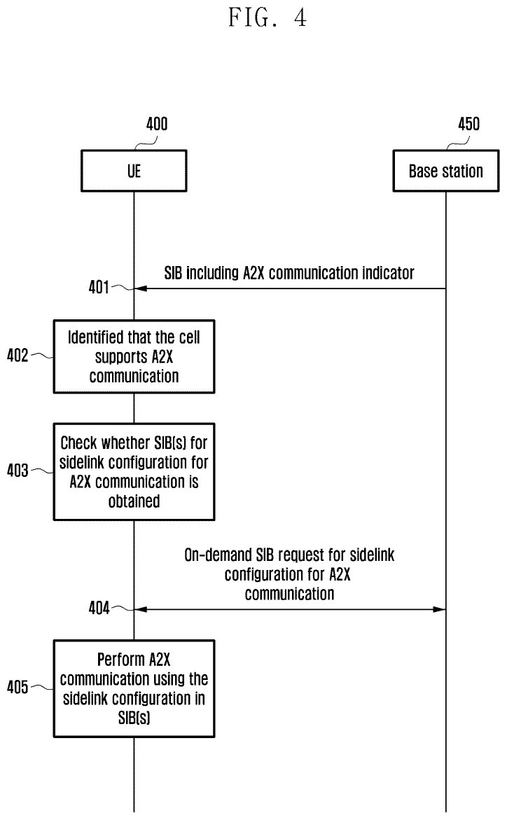

According to the embodiment of FIG. 3, if it is determined that the base station 350 supports the UE-to-UE direct communication-based A2X communication, the UE 300 may determine whether to obtain configuration information and sidelink transmission/reception resource information for performing UE-to-UE direct communication-based A2X communication from the base station 350. For example, the UE 300 may determine whether to obtain a specific SIB message including the configuration information and sidelink transmission/reception resource information for performing A2X communication from the corresponding base station 350. A specific SIB message including the configuration information and sidelink transmission/reception resource information for performing A2X communication may be the same SIB message as the SIB message including the indication information indicating that the base station 350 supports UE-to-UE direct communication-based A2X communication, or may be a separate SIB message. In relation to this, the operation for the UE to process the SIB message including the configuration information and resource information for performing A2X communication from the base station will be described with reference to the embodiment of FIG. 4.

The embodiment of FIG. 4 may be applied to a case where the UE performs LTE RAT-based A2X communication or a case where the UE performs NR RAT-based A2X communication.

FIG. 4 illustrates a signaling flow between a terminal and a base station that processes A2X communication configuration information in a wireless communication system according to an embodiment of the disclosure.

With reference to FIG. 4, a UE 400 is authenticated to transmit and receive A2X service messages using A2X communication using a UE-to-UE direct communication scheme. The UE 400 may receive the SIB message transmitted by a base station 450 and obtain information indicating whether the base station 450 supports A2X communication. Here, the base station 450 may include a serving cell of the UE 400. Information indicating whether the base station 450 supports A2X communication may be included in the SIB message transmitted by the base station 450. An example of information included in the SIB message, which indicates whether the base station 450 supports A2X communication, may be as shown in [Table 4] above.

If the UE 400 obtains the SIB message including the information indicating whether the base station 450 supports A2X communication in operation 401, the UE 400 may determine that the base station 450 may support A2X communication in operation 402. In operation 403, the UE 400 may determine whether to obtain a SIB message including sidelink configuration information necessary to perform A2X communication (e.g., one or a plurality of SIB messages may be constituted to be used for providing sidelink configuration information necessary to perform A2X communication) from the base station 450 that may support A2X communication.

In operation 403, if the UE 400 fails to obtain from the base station 450 the SIB message including sidelink configuration information necessary to perform A2X communication, as a more specific example, in case that the UE 400 fails to obtain from the base station 450 one or a plurality of SIB messages including information necessary for transmitting and receiving A2X service messages using A2X communication, the UE 400 may perform an on-demand SIB request procedure to request the base station 450 to transmit one or a plurality of SIB messages necessary for A2X communication in operation 404.

In operation 404, the on-demand SIB request message transmitted by the UE 400 to the base station 450 may include information indicating one or a plurality of SIB messages that need to be provided by the base station 450, which is necessary for the UE 400 to transmit and receive A2X service messages using A2X communication, but has not been determined to be obtained from the base station 450. In operation 404, if the base station 450 receives the on-demand SIB request message requesting transmission of one or a plurality of SIB messages necessary for A2X communication from the UE 400, the base station 450 may transmit, to the UE 400, one or a plurality of SIB messages requested by the UE 400. When the base station 450 transmits, to the UE 400, one or a plurality of SIB messages necessary for A2X communication to the UE 400 in response to the on-demand SIB request message, at least one SIB message requested by the UE 400 may be broadcasted or transmitted through a dedicated message to the UE 400.

The UE 400 may perform A2X communication in operation 405 using one or a plurality of SIB messages including configuration information for A2X communication obtained from the base station 450 in operations 403 to 404. The operations that the UE 400 may perform in operation 405 may include, for example, configuring a sidelink radio bearer for A2X communication, data transmission and reception operations based on A2X communication, etc. In this case, the one or plurality of SIB messages acquired by the UE 400 may include at least one of sidelink radio bearer configuration information of A2X communication for configuring the sidelink radio bearer of the A2X communication, transmission resource configuration information for A2X communication for data transmission and reception based on the A2X communication, and reception resource configuration information for A2X communication.

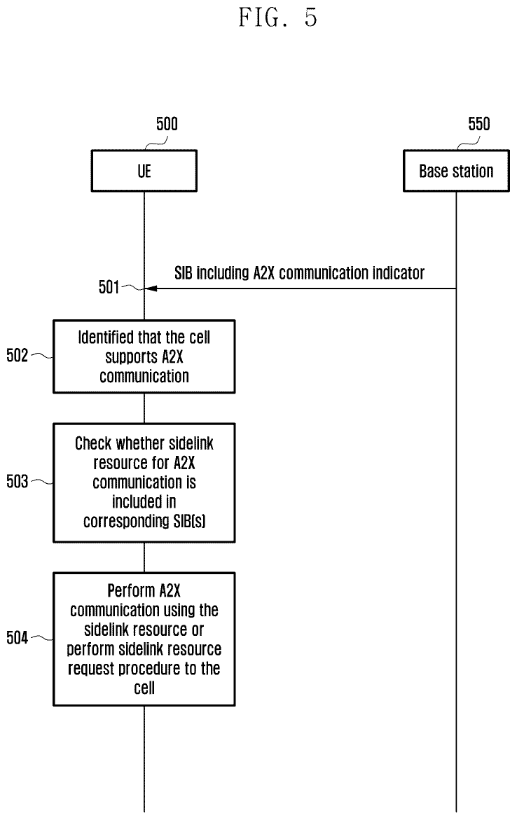

When the UE obtains the SIB message including configuration information for A2X communication from the base station that may support A2X communication, the SIB message including configuration information for A2X communication may not include transmission resource configuration for A2X communication. In this case, the UE may perform an operation of transitioning to radio resource control (RRC) connected mode (RRC_CONNECTED) to request A2X communication transmission resources from the base station, and may perform an operation of requesting A2X communication transmission resources from the base station. Hereinafter, with reference to the embodiment of FIG. 5, the operation performed by the UE in case that the A2X communication transmission resource configuration is not included in the SIB message for A2X communication will be described.

FIG. 5 illustrates a signaling flow between a terminal and a base station that processes A2X communication transmission resources in a wireless communication system according to an embodiment of the disclosure.

With reference to FIG. 5, a UE 500 is authenticated to transmit and receive A2X service messages using A2X communication using a UE-to-UE direct communication scheme. The UE 500 may receive the SIB message transmitted by a base station 550 and obtain information indicating whether the base station 550 supports A2X communication. Here, the base station 550 may include a serving cell of the UE 500. Information indicating whether the base station 550 supports A2X communication may be included in the SIB message transmitted by the base station 550. In this case, examples of information included in the SIB message, which indicates whether the base station 550 supports A2X communication, are as detailed in [Table 4].

If the UE 500 obtains a SIB message including information indicating whether the base station 550 supports A2X communication in operation 501, the UE 500 may determine that the base station 550 may support A2X communication in operation 502.

In operation 503, the UE 500 may determine whether the SIB message including sidelink configuration information necessary to perform A2X communication (e.g., one or a plurality of SIB messages may be constituted to be used to provide sidelink configuration information necessary to perform A2X communication) is obtained from the base station 550 that may support A2X communication.

In operation 503, if the SIB message including sidelink configuration information necessary to perform A2X communication is not obtained from the base station 550, the UE 500 may perform, as in the embodiment of FIG. 4, an on-demand SIB request procedure that requests the base station 550 to transmit one or a plurality of SIB messages necessary for A2X communication. In operation 503, if one or a plurality of SIB messages including sidelink configuration information necessary to perform A2X communication are obtained from the base station 560, the UE 500 may determine whether the one or plurality of SIB messages obtained includes the sidelink transmission resource configuration information necessary to perform the A2X communication.

In operation 503, if it is determined that the obtained one or a plurality of SIB messages for A2X communication include side link transmission resource configuration information necessary to perform A2X communication, the UE 500 may perform a transmission resource allocation operation to transmit an A2X service message using the sidelink transmission resource configuration information necessary to perform A2X communication (for example, a mode operation in which the UE directly allocates transmission resources) in operation 504, and perform an operation to transmit the A2X service message based on the transmission resource allocation operation. In operation 503, if at least one of the transmission resource configuration for supporting sidelink transmission on the same carrier as the base station 550, and the transmission resource configuration for supporting sidelink transmission on a different carrier than the base station 550 or a combination thereof is included in the at least one obtained SIB message, the UE 500 may determine that the sidelink transmission resource configuration is included in the at least one SIB message.

In operation 503, if it is determined that the obtained one or plurality of SIB messages for A2X communication do not include the sidelink transmission resource configuration information necessary to perform the A2X communication, the UE 500 may perform an operation to request sidelink transmission resources from the base station 550 capable of supporting A2X communication in operation 504. The operations performed by the UE 500 in operation 504 may include, for example, an operation in which the UE 500 transitions to the RRC connected mode (RRC_CONNECTED) and an operation in which the UE 500 requests the resource necessary to transmit an A2X service message of A2X communication to the base station 550. The sidelink transmission resource request for A2X communication, which is transmitted from the UE 500 to the base station 550 in operation 504, may be included, for example, in a SidelinkUEInformation message, and embodiments related thereto may be as defined in [Table 10], which will be described later.

In the example of [Table 4], the indication information indicating whether the base station supports the UE direct communication-based A2X communication, which has been described above as information indicated in the SIB message, may be used to inform the sidelink transmission resource allocation mode supported in the serving cell of the UE/base station. For example, in [Table 4], the information indicated in the SIB message may be used as information informing that the base station supports the UE direct communication-based A2X communication and that the sidelink transmission resource allocation mode is the UE direct allocation mode. In this case, as an example, a specific sidelink transmission resource allocation mode may be indicated based on information supporting A2X communication being configured in the SIB message. As another example, in order to provide the UE with information informing that the base station supports the UE direct communication-based A2X communication and that the sidelink transmission resource allocation mode is the base station allocation mode, the base station may transmit additional indication information to the UE, in addition to the information indicated in the SIB message in [Table 4]. For example, the base station may include configuration information or indication information that may indicate the allocation mode of sidelink transmission resources in the SIB message, separately from the existing information that supports A2X communication.

As an example related to the above, [Table 6] below illustrates information that the base station supports A2X communication and indication information that informs the UE of the sidelink transmission resource allocation mode.

```
TABLE 6
SIB_A2X-IEs-r18 may include one of Option 1, Option 2, and Option 3 in [Table 4]. If
sl-A2X-Communication IE is configured to be enabled, the UE may determine that the
base station may support A2X communication. In addition, if sl-A2X-Communication
IE is configured to be enabled, the UE may determine that the sidelink transmission
resource allocation mode is a UE direct allocation mode. For example, the UE direct
allocation mode may refer to Mode 4 in case of using an LTE RAT, and Mode 2 in case
of using an NR RAT.
SIB_A2X-IEs-r18 ::= SEQUENCE {
  sl-A2X-Communication ENUMERATED {enabled}, OPTIONAL,
  sl-ConfigCommon SL-ConfigCommon, //without network scheduled sidelink
resource allocation mode configuration
  lateNonCriticalExtension OCTET STRING OPTIONAL,
  ...,
}
SIB_A2X_IEs-19 may be included in the SIB message transmitted from the base station
to the UE in one of Option 1, Option 2, and Option 3 in [Table 4]. If sl-A2X-
Communication IE is configured to be enabled, the UE may determine that the base
station may support A2X communication. In addition, if sl-A2X-Communication IE is
configured to be enabled, the UE may determine that the sidelink transmission resource
allocation mode is the UE direct allocation mode and base station allocation mode. For
example, the UE direct allocation mode may refer to Mode 4 in case of using an LTE
RAT, and Mode 2 in case of using an NR RAT. For example, the base station allocation
mode may refer to Mode 3 in using an LTE RAT, and Mode 1 in case of using an NR
RAT.
SIB_A2X-IEs-19 ::= SEQUENCE {
  sl-A2X-Communication ENUMERATED {enabled}, OPTIONAL,
  sl-ConfigCommon SL-ConfigCommon, //with network scheduled sidelink resource
allocation mode configuration
  lateNonCriticalExtension OCTET STRING OPTIONAL,
  ....
}
```

According to the embodiment of [Table 6], in case that the base station may support A2X communication and the sidelink transmission resource allocation mode may only support the UE direct allocation mode, the SIB message including SIB_A2X-IEs-18 may be transmitted to the UE. In contrast, in case that the base station may support A2X communication and the sidelink transmission resource allocation mode may support both the UE direct allocation mode and the base station allocation mode, the SIB message including SIB_A2X-IEs-19 may be transmitted to the UE. In the latter case, the base station may not include SIB_A2X-IEs-18 in the SIB message transmitted to the UE. The SIB_A2X-IEs-19 configuration information included in the SIB message transmitted by the base station may further include configuration information necessary to operate the sidelink transmission resource allocation mode of the UE direct allocation mode.

If the UE determines from the obtained SIB message that the base station may support A2X communication and the sidelink transmission resource allocation mode of the base station allocation mode may be supported, the UE may report to the base station UE capability indicating that the UE has the capability to support the sidelink transmission resource allocation mode of the base station allocation mode.

As another example, [Table 7] below illustrates indication information that informs the UE of the sidelink transmission resource allocation mode in addition to information that the base station supports A2X communication.

```
TABLE 7
SIB_A2X-IEs-r18 may include one of Option 1, Option 2, and Option 3 in [Table 4]. If
sl-A2X-Communication IE is configured to be enabled, the UE may determine that the
base station may support A2X communication. In addition, if sl-A2X-Communication
IE is configured to be enabled, the UE may determine that the sidelink transmission
resource allocation mode is the UE direct allocation mode. For example, the UE direct
allocation mode may refer to Mode 4 in case of using an LTE RAT, and Mode 2 in case
of using an NR RAT.
If sl-A2X-Communication IE is configured to be enabled and sl-
NWScheduledModeforA2XCommunication IE is configured to be enabled, the UE may
determine that the sidelink transmission resource allocation mode supported by the base
station is the UE direct allocation mode and the base station allocation mode. For
example, the UE direct allocation mode may refer to Mode 4 in case of using an LTE
RAT, and Mode 2 in case of using an NR RAT. For example, the base station allocation
mode may refer to Mode 3 in case of using an LTE RAT, and Mode 1 in case of using
an NR RAT.
SIB_A2X-IEs-r18 ::=  SEQUENCE {
  sl-A2X-Communication  ENUMERATED {enabled} OPTIONAL,
  sl-ConfigCommon  SL-ConfigCommon, //without network scheduled sidelink
resource allocation mode configuration
  lateNonCriticalExtension OCTET STRING  OPTIONAL,
  ...
  sl-NWScheduledModeforA2XCommunication-r19  ENUMERATED {enabled}
OPTIONAL,
  ...
}
```

According to the embodiment of [Table 7], in case that the base station may support A2X communication and the sidelink transmission resource allocation mode may only support the UE direct allocation mode, the SIB message in which sl-A2X-Communication IE of SIB_A2X-IEs-18 is configured to be enabled may be transmitted to the UE. As another example, in case that the base station may support A2X communication and the sidelink transmission resource allocation mode may support both the UE direct allocation mode and the base station allocation mode, the SIB message in which sl-A2X-Communication IE of SIB_A2X-IEs-18 is configured to be enabled and sl-NWScheduledModeforA2Xcommunication IE is configured to be enabled may be transmitted to the UE. In the latter case, the base station may include additional configuration information necessary to support the sidelink transmission resource allocation mode of the base station allocation mode in SIB_A2X-IEs-18, in the SIB message transmitted to the UE.

In this way, in case that the SIB message transmitted from the base station to the UE includes the configuration information necessary to support the sidelink transmission resource allocation mode of the base station allocation mode in SIB_A2X-IEs-18, it is apparent that this configuration information may be used in the sidelink transmission resource allocation mode of the UE direct allocation mode in addition to the sidelink transmission resource allocation mode of the base station allocation mode, and the configuration information used only in the UE direct allocation mode may not be used. Among the configuration information included in SIB_A2X-IEs-18, as to which configuration information the UE may use, that is, as to whether the additionally defined configuration information to support the sidelink transmission resource allocation mode of the base station allocation mode will be used in the UE direct allocation mode, or whether the configuration information that has been configured to be used only in the UE direct allocation mode may be used in the UE direct allocation mode, the base station may indicate to the UE. Based on the obtained SIB message, if the UE determines that the base station may support A2X communication and the sidelink transmission resource allocation mode of the base station allocation mode, the UE may report to the base station UE capability indicating that the UE has the capability to support the sidelink transmission resource allocation mode of the base station allocation mode.

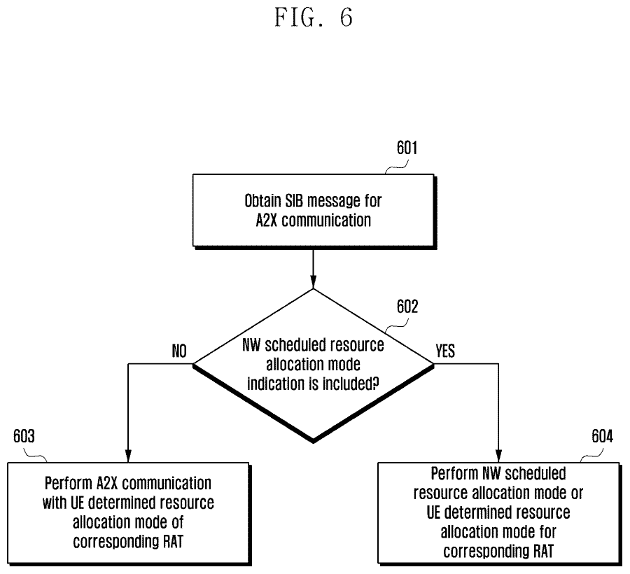

Hereinafter, with reference to FIG. 6, the operation of the UE to determine and process the sidelink transmission resource allocation mode that may be used by the base station determined to support A2X communication according to the embodiments of [Table 6] to [Table 7] will be described.

FIG. 6 illustrates an operation of the UE that processes an A2X communication transmission resource allocation mode in a wireless communication system according to an embodiment of the present disclosure.

With reference to FIG. 6, in operation 601, the UE may receive one or a plurality of SIB messages for A2X communication transmitted by the base station, and determine whether the base station supports A2X communication based on the received SIB messages. For example, the UE may obtain one or a plurality of SIB messages including sidelink configuration information for A2X communication transmitted by the base station in operation 601. Examples of SIB messages including information on whether the base station supports A2X communication, that is, sidelink configuration information for A2X communication have been described in at least one of [Table 4], [Table 5], [Table 6], and [Table 7] or a combination thereof.

In operation 602, the UE may determine whether the base station resource allocation mode in which the base station allocates sidelink transmission resources for A2X communication is supported based on the information in [Table 6] to [Table 7].

In operation 602, if it is determined that the base station resource allocation mode is not supported, the UE proceeds to operation 603 and may perform A2X communication, such as transmitting an A2X service message according to a mode for directly allocating sidelink transmission resources. In operation 603, the UE may perform A2X communication using sidelink configuration information for A2X communication included in the SIB message, which is at least one SIB message or combination of SIB messages for A2X communication obtained in operation 601, and may perform LTE RAT-based A2X communication or NR RAT-based A2X communication. In operation 603, in case of being necessary or indicated, the UE may receive sidelink configuration information for A2X communication from the base station through a dedicated RRC message and then use the received sidelink configuration information to perform A2X communication.

If it is determined in operation 602 that the base station resource allocation mode is supported, the UE proceeds to operation 604 and may perform A2X communication, such as transmitting an A2X service message according to a mode in which the UE directly allocates sidelink transmission resources or a mode in which the base station allocates sidelink transmission resources. In operation 604, the UE may perform A2X communication using sidelink configuration information for A2X communication included in the SIB message, which is at least one SIB message or combination of SIB messages for A2X communication obtained in operation 601, and may perform LTE RAT-based A2X communication or NR RAT-based A2X communication. In operation 604, in case of being necessary or indicated, the UE may receive sidelink configuration information and transmission resource information for A2X communication from the base station through a dedicated RRC message and then perform A2X communication using the received information. In case that the UE uses a mode in which the base station allocates sidelink transmission resources, the UE may perform A2X communication using the sidelink transmission resources allocated by the base station. The UE may determine that the base station supports a mode for allocating sidelink transmission resources, and if the UE may also support the sidelink transmission resource allocation mode of the base station allocation mode, the UE may transmit the base station UE capability message including information that the UE has the ability to support the base station allocation mode.

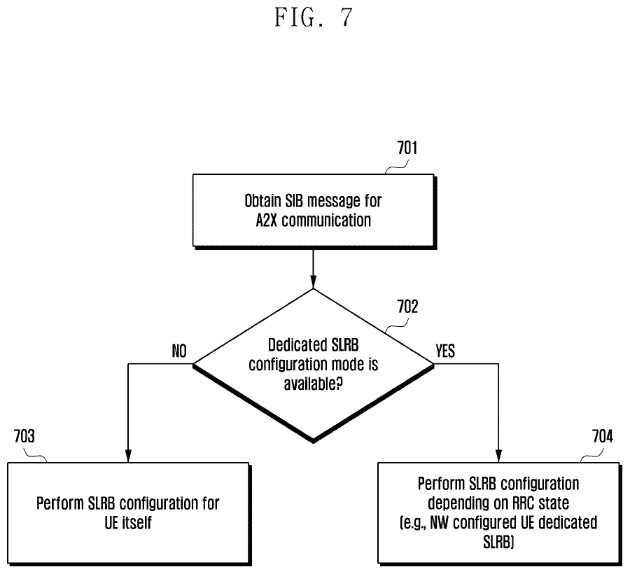

When performing A2X communication, the UE needs to process not only the sidelink transmission resource allocation mode but also the sidelink radio bearer (signaling bearer and data bearer) configuration for A2X communication. For example, when the UE configures a sidelink data bearer to transmit an A2X service message, an option for the UE to configure the data bearer directly and an option for the base station to configure the data bearer for the UE may be considered. In this case, the bearer configuration option may be determined according to the RAT type used by the UE in A2X communication. For example, in case that the UE performs LTE RAT-based A2X communication, an option for the UE to directly configure the data bearer may be applied. As another example, an option for the base station to configure a data bearer directly for the UE in case that the UE performs NR RAT-based A2X communication, and an option to use data bearer configuration pre-configured for the UE in case that the UE is outside the coverage of the base station may be applied. In another embodiment, as in the case of the sidelink transmission resource allocation mode in [Table 6] to [Table 7], the option for the UE to directly configure the bearer and the option for the base station to configure the bearer of the UE may be determined based on the configuration information included in the SIB message for A2X communication. Hereinafter, with reference to FIG. 7, the operation of the UE that determines the bearer configuration option based on the configuration information included in the SIB message for A2X communication will be described.

FIG. 7 illustrates an operation of the UE that processes A2X communication radio bearer configuration in a wireless communication system according to an embodiment of the present disclosure.

With reference to FIG. 7, the UE may receive one or a plurality of SIB messages for A2X communication transmitted by the base station in operation 701 and determine whether the base station supports A2X communication. The UE may obtain one or a plurality of SIB messages including sidelink configuration information for A2X communication transmitted by the base station in operation 701. It has been described above that examples of SIB messages including information on whether the base station supports A2X communication and sidelink configuration information for A2X communication may be defined by at least one of [Table 4], [Table 5], [Table 6], and [Table 7] or a combination thereof.

In operation 702, the UE may determine whether a mode in which the base station configures a sidelink radio bearer for A2X communication is supported based on the information in [Table 6] to [Table 7]. Alternatively, according to another embodiment, in case that in operation 702, the base station provides the UE with information on whether it supports a mode that configures a sidelink radio bearer for A2X communication through separate signaling, the UE may determine whether a mode in which the base station configures the sidelink radio bearer for A2X communication is supported, based on the corresponding signaling.

In operation 702, if it is determined that the mode in which the base station configures the sidelink radio bearer for A2X communication is not supported, the UE proceeds to operation 703 and may configure a radio bearer to be used for transmitting and receiving an A2X communication-based A2X service message according to the mode in which the UE directly configure a sidelink radio bearer. As an embodiment, in operation 703, the UE may configure the radio bearer configuration to be used for transmitting and receiving the A2X service messages according to the UE's arbitrary determination (based on information obtained by UE implementation or information implemented obtained from the server that controls A2X communication). In another embodiment, in operation 703, the UE may configure a radio bearer by obtaining configuration information of the radio bearer to be used for transmitting and receiving the A2X service message from configuration information preconfigured to the UE.

In another embodiment, in operation 703, the UE may obtain the radio bearer configuration information to be used for transmitting and receiving the A2X service message from at least one SIB message or combination of SIB messages for A2X communication obtained from the base station in operation 701, and then configure a radio bearer using the obtained radio bearer configuration information. In this case, in case that the UE configures a radio bearer using the radio bearer configuration information preconfigured to the UE or the radio bearer configuration information obtained from at least one SIB message or combination of SIB messages for A2X communication received from the base station, the radio bearer configuration information may include quality of service (QoS) profile information that may be mapped to an A2X service, for example, QoS profile, radio bearer configuration that may be mapped to proximity services (ProSe) QoS Indicator (PQI), etc. In this case, the UE may identify the QoS profile information mapped to the A2X service and determine the configuration information of the radio bearer mapped to the identified QoS profile information.

Regardless of the UE's RRC state, the UE may process a radio bearer configuration operation using radio bearer configuration information included in at least one SIB message or combination of SIB messages for A2X communication received from the base station. Alternatively, the UE may process a radio bearer configuration operation using the radio bearer configuration information preconfigured to the UE, regardless of the UE's RRC state. Alternatively, in case that the UE is in one of the RRC states of RRC_CONNECTED, RRC_INACTIVE, and RRC_IDLE, the UE may process a radio bearer configuration operation using radio bearer configuration information included in at least one SIB message or combination of SIB messages for A2X communication received from the base station. If it is determined that the UE exists outside the coverage of the base station, the UE may process the radio bearer configuration operation using the radio bearer configuration information pre-configured to the UE.

In operation 702, if it is determined that a mode in which the base station configures a sidelink radio bearer for A2X communication is supported, the UE proceeds to operation 704, and an option for the base station to configure a data bearer to the UE according to the UE's RRC state may be applied (in the case of RRC_CONNECTED, the base station configures a data bearer to the UE using a dedicated RRC message, in the case of RRC_IDLE or RRC_INACTIVE, a radio bearer is configured using the radio bearer configuration information included in the SIB message for A2X communication received from the base station). In case that the UE exists outside the coverage of the base station, an option for configuring a radio bearer using the radio bearer configuration information preconfigured to the UE may be applied. In case that the UE performs a radio bearer configuration operation using the radio bearer configuration information included in the SIB message for A2X communication, or a radio bearer configuration operation using the radio bearer configuration information preconfigured to the UE in operation 704, the SIB message or preconfigured radio bearer configuration information may include QoS profile information that may be mapped to the A2X service, for example, radio bearer configuration that may be mapped to QoS profile, ProSe QoS Indicator (PQI), etc. In this case, the UE may identify the QoS profile information mapped to the A2X service and determine the configuration information of the radio bearer mapped to the identified QoS profile information.

According to various embodiments of the disclosure, an embodiment of an operation in which the UE obtains and processes at least one SIB message or combination of SIB messages for A2X communication may be as defined in [Table 8] below.

TABLE 8
Embodiments of configuration information that may be included in at least one SIB
message or combination of SIB messages for A2X communication may include
information of at least one of [Table 4], [Table 5], [Table 6], and [Table 7] or
combination of information.
UE's actions upon reception of SIB for A2X communication with sl-A2X-
Communication is set as enabled (i.e., UE's actions upon reception of SIB_A2X
SIB_A2X described here is not limited to [Table 5])
Upon receiving the SIB for A2X communication, the UE may:
1> if the UE has stored at least one segment of SIB_A2X and the value tag of SIB_A2X
has changed since a previous segment was stored:
2> discard all stored segments;
1> store the segment;
1> if all segments have been received:
2> assemble SIB_A2X-IEs from the received segments;
2> if sl-FreqInfoList is included in sl-ConfigCommon:
3> if configured to receive A2X communication:
4> use the resource pool(s) indicated by sl-RxPool for A2X communication reception;
3> if configured to transmit A2X communication:
4> use the resource pool(s) indicated by sl-TxPoolSelectedNormal, or sl-
TxPoolExceptional for A2X communication transmission;
4> perform CBR measurement on the transmission resource pool(s) indicated by sl-
TxPoolSelectedNormal or sl-TxPoolExceptional for A2X communication transmission;
4> use the synchronization configuration parameters for A2X communication on
frequencies included in sl-FreqInfoList;
2> if sl-RadioBearerConfigList is included in sl-ConfigCommon:
3> perform sidelink DRB addition/modification/release for A2X communication;
SIB_A2X may correspond to a SIB message in LTE format or a SIB message in NR
format, and the UE may perform LTE RAT-based A2X communication based on the
SIB message in LTE format or NR RAT-based A2X communication based on the SIB
message in NR format.

In addition, according to various embodiments of the disclosure, examples of conditions under which the UE performs an operation of transmitting and receiving an A2X service message using UE direct communication-based A2X communication may be as shown in [Table 9] below.

TABLE 9
The UE may perform A2X communication operation only if the
conditions defined in this clause are met:
1> if the UE's serving cell is suitable (RRC_IDLE or RRC_INACTIVE
or RRC_CONNECTED); and if either the selected cell on the frequency
used for A2X communication operation belongs to the registered or
equivalent PLMN or the UE is out of coverage on the frequency used for
A2X communication operation; or
1> if the UE's serving cell (RRC_IDLE or RRC_CONNECTED) fulfils
the conditions to support A2X communication in limited service state;
and if either the serving cell is on the frequency used for A2X
communication operation or the UE is out of coverage on the frequency
used for A2X communication operation; or
1> if the UE has no serving cell (RRC_IDLE).

In addition, according to various embodiments of the disclosure, a request for sidelink transmission resources transmitted by the UE to the base station supporting A2X communication, and the like may be included in the SidelinkUEInformation message, and an example of transmitting such a SidelinkUEInformation message may be as shown in [Table 10] below.

TABLE 10
A UE capable of A2X communication operation that is in RRC_
CONNECTED may initiate the procedure to indicate it is (interested in)
receiving or transmitting A2X communication operation in several cases
including upon successful connection establishment or resuming, upon
change of interest, upon changing QoS profile(s), or upon change to a
PCell providing SIB_A2X (it is not limited to the embodiment in
[Table 5] and includes one or a plurality of SIBs for A2X communication)
including sl-ConfigCommon.
A UE capable of A2X communication may initiate the procedure to
request assignment of dedicated sidelink DRB (data radio bearer)
configuration for A2X communication and transmission resources for
A2X communication transmission.

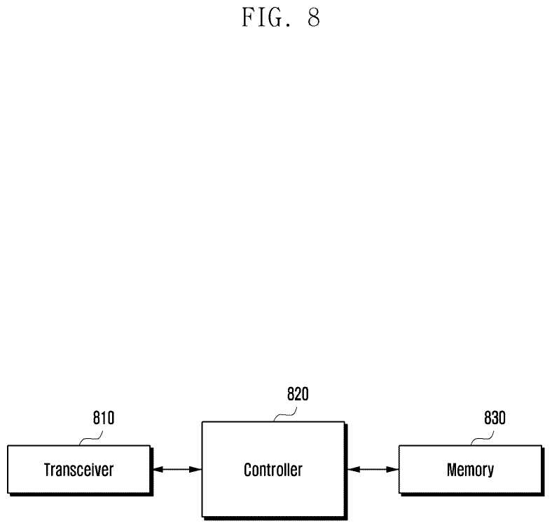

FIG. 8 illustrates a structure of a UE according to an embodiment of the present disclosure.

With reference to FIG. 8, the UE may include a transceiver 810, a controller 820, and memory 830. The transceiver 810, controller 820, and the memory 830 may operate according to the communication method of the UE described above. However, the components of the UE are not limited to the above examples. For example, the UE may include more or fewer components compared to the above-described components. In addition, the UE may the transceiver 810 and the controller 820. Further, the transceiver 810, controller 820, and memory 830 may be implemented in the form of a single chip.

The transceiver 810 collectively refers to the receiver of the UE and the transmitter of the UE, and may transmit and receive signals to and from the base station, other terminals, or network entities. A signal transmitted and received with the base station may include control information and data. For example, the transceiver 810 may receive system information from the base station and may receive a synchronization signal or a reference signal. To this end, the transceiver 810 may include an RF transmitter that up-converts and amplifies the frequency of a transmitted signal, an RF receiver that amplifies a received signal with low noise and down-converts its frequency, and the like. However, this is only one embodiment of the transceiver 810, and components of the transceiver 810 are not limited to the RF transmitter and the RF receiver. In addition, the transceiver 810 may include a wired or wireless transceiver, and may include various components for transmitting and receiving signals. In addition, the transceiver 810 may receive a signal through a wireless channel, output the signal to the controller 820, and transmit the signal output from the controller 820 through a wireless channel. In addition, the transceiver 810 may receive and output a communication signal to a processor, and transmit the signal output from the processor to a network entity through a wired or wireless network.

The memory 830 may store programs and data required for operation of the UE. In addition, the memory 830 may store control information or data included in a signal obtained from the UE. The memory 830 may include a storage medium, such as a ROM, a RAM, a hard disk, a CD-ROM, and a DVD, or a combination of storage media.

In the disclosure, the controller 820 may be defined as a circuit or an application-specific integrated circuit or at least one processor. The processor may include a communication processor (CP) for controlling communication and an application processor (AP) for controlling upper layers, such as application programs. The controller 820 may control overall operations of the UE according to an embodiment provided in the disclosure. For example, the controller 820 may control a signal flow between blocks to perform an operation according to the flowchart described above.

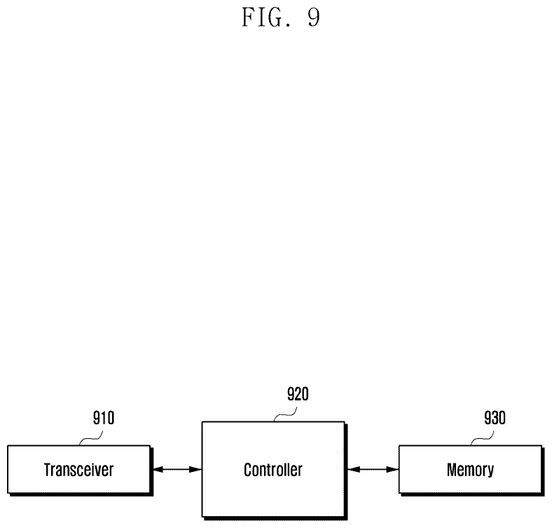

FIG. 9 illustrates a structure of a base station according to an embodiment of the present disclosure.

With reference to FIG. 9, the base station according to an embodiment of the disclosure may include a transceiver 910, a controller 920, and a storage 930. The transceiver 910, controller 920, and storage 930 may operate according to the communication method of the base station described above. However, components of the base station are not limited to the above-described examples. For example, the base station may include more or fewer components than those described above. For example, the base station may include the transceiver 910 and the controller 920, and the transceiver 910 may additionally include a backhaul communicator for communication with other network entities. In addition, the transceiver 910, controller 920, and storage 930 may be implemented in a single chip form.

The transceiver 910 collectively refers to the receiver of the base station and the transmitter of the base station, and may transmit and receive signals with other base stations, the terminal, or other network devices. The signal to be transmitted and received through wireless communication with the UE may include control information and data. For example, the transceiver 910 may transmit system information to the UE and may transmit a synchronization signal or a reference signal. To this end, the transceiver 910 may include an RF transmitter that up-converts and amplifies the frequency of a transmitted signal, an RF receiver that amplifies a received signal with low noise and down-converts its frequency, and the like. However, this is only one embodiment of the transceiver 910, and components of the transceiver 910 are not limited to the RF transmitter and the RF receiver. In addition, the transceiver 910 may include a wired or wireless transceiver, and may include various constitutions for transmitting and receiving signals. In addition, the transceiver 910 may receive a signal through a wireless channel, output the signal to the controller 920, and transmit the signal output from the controller 920 through the wireless channel. In addition, the transceiver 910 may receive and output a communication signal to a processor, and transmit the signal output from the processor to other network entities through a wired or wireless network.

The storage 930 may store data such as basic programs, applications, and configuration information necessary for the operation of the base station. In addition, the storage 930 may store data such as configuration information on bearers to be assigned to connected terminals and system information to be provided to terminals in the serving area. In addition, the storage 930 may provide the stored data according to a request of the controller 920.

In the disclosure, the controller 920 may be defined as a circuit or an application-specific integrated circuit or at least one processor. The processor may include a communication processor (CP) for controlling communication and an application processor (AP) for controlling upper layers, such as application programs. The controller 920 may control the overall operation of the base station according to the embodiment provided in the disclosure. For example, the controller 920 may control signal flow between blocks to perform an operation according to the flowchart described above.

Methods according to the embodiments described in the claims or specification of the disclosure may be implemented in the form of hardware, software, or a combination of hardware and software.

In case of being implemented in software, a computer readable storage medium storing one or more programs (software modules) may be provided. One or more programs stored in a computer-readable storage medium are configured for execution by one or more processors in an electronic device. One or more programs include instructions that cause the electronic device to execute methods according to embodiments described in the claims or specification of the disclosure.

Such programs (software modules, software) may be stored in a random access memory, a non-volatile memory including a flash memory, a read only memory (ROM), and an electrically erasable programmable ROM (EEPROM), magnetic disc storage device, a compact disc-ROM (CD-ROM), digital versatile discs (DVDs), or other forms of optical storage devices, magnetic cassettes. Alternatively, it may be stored in a memory composed of a combination of some or all of these. In addition, each configuration memory may be included in multiple numbers.

In addition, the program may be stored on an attachable storage device that can be accessed through a communication network, such as the Internet, an Intranet, a local area network (LAN), a wide LAN (WLAN), or a storage area network (SAN), or a communication network composed of a combination thereof. Such a storage device may be connected to a device performing an embodiment of the disclosure through an external port. In addition, a separate storage device on a communication network may be connected to a device performing an embodiment of the disclosure.

In the specific embodiments of the disclosure described above, components included in the disclosure are expressed in singular or plural numbers according to the specific embodiments presented. However, the singular or plural expressions are selected appropriately for the presented situation for convenience of description, and the disclosure is not limited to singular or plural components, and even a component expressed in the plural may be composed of a singular number, or a component expressed in the singular may be composed of a plural number.

Meanwhile, in the detailed description of the disclosure, specific embodiments have been described, but it is apparent that various modifications are possible without departing from the scope of the disclosure. Therefore, the scope of the disclosure should not be limited to the described embodiments, but should be determined not only by the scope of the claims described later, but also by the scope of the claim and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a message including first information on a resource to perform sidelink communication;
identifying whether the message further includes second information on a resource pool to perform an aircraft to everything (A2X) communication; and
in case that the message further includes the second information, performing the A2X communication with another terminal using at least one resource indicated by the second information,
wherein the terminal is configured to perform the A2X communication for an A2X service.

2. The method of claim 1, wherein the message is a system information block (SIB) message, in case that the terminal is in a radio resource control (RRC) inactive state or an RRC idle state, and the message is an RRC message, in case that the terminal is in an RRC connected state, and
wherein the at least one resource includes a resource by which the terminal is allowed to receive the A2X communication for the A2X service and a resource by which the terminal is allowed to transmit the A2X communication for the A2X service.

3. The method of claim 1, wherein the at least one resource is dedicated for the A2X service based on the second information, and
wherein the A2X service includes at least one broadcast remote identification (BRID) or detected and avoid (DAA).

4. The method of claim 1, further comprising:
transmitting, to the base station, capability information including information indicating that the A2X service is supported by the terminal.

5. A method performed by a base station in a wireless communication system, the method comprising:
generating first information on a resource to perform sidelink communication and second information on a resource pool to perform an aircraft to everything (A2X) communication; and
transmitting, to a terminal, a message including the first information and the second information,
wherein the terminal is configured to perform the A2X communication for an A2X service, and
wherein at least one resource indicated by the second information is used for performing the A2X communication between the terminal and another terminal.

6. The method of claim 5, wherein the message is a system information block (SIB) message or a radio resource control (RRC) message, and
wherein the at least one resource includes a resource by which the terminal is allowed to receive the A2X communication for the A2X service and a resource by which the terminal is allowed to transmit the A2X communication for the A2X service.

7. The method of claim 5, wherein the at least one resource is dedicated for the A2X service based on the second information, and
wherein the A2X service includes at least one broadcast remote identification (BRID) or detected and avoid (DAA).

8. The method of claim 5, further comprising:
receiving, from the terminal, capability information including information indicating that the A2X service is supported by the terminal.

9. A terminal in a wireless communication system, the terminal comprising:
a transceiver; and
a controller configured to:
control the transceiver to receive, from a base station, a message including first information on a resource to perform sidelink communication,
identify whether the message further includes second information on a resource pool to perform an aircraft to everything (A2X) communication, and
in case that the message further includes the second information, perform the A2X communication with another terminal using at least one resource indicated by the second information,
wherein the terminal is configured to perform the A2X communication for an A2X service.

10. The terminal of claim 9, wherein the message is a system information block (SIB) message, in case that the terminal is in a radio resource control (RRC) inactive state or an RRC idle state, and the message is an RRC message, in case that the terminal is in an RRC connected state, and
wherein the at least one resource includes a resource by which the terminal is allowed to receive the A2X communication for the A2X service and a resource by which the terminal is allowed to transmit the A2X communication for the A2X service.

11. The terminal of claim 9, wherein the at least one resource is dedicated for the A2X service based on the second information, and
wherein the A2X service includes at least one broadcast remote identification (BRID) or detected and avoid (DAA).

12. The terminal of claim 9, wherein the controller is further configured to control the transceiver to transmit, to the base station, capability information including information indicating that the A2X service is supported by the terminal.

13. A base station in a wireless communication system, the base station comprising:
a transceiver; and
a controller configured to:
generate first information on a resource to perform sidelink communication and second information on a resource pool to perform an aircraft to everything (A2X) communication, and
control the transceiver to transmit, to a terminal, a message including the first information and the second information,
wherein the terminal is configured to perform the A2X communication for an A2X service, and
wherein at least one resource indicated by the second information is used for performing the A2X communication between the terminal and another terminal.

14. The base station of claim 13, wherein the message is a system information block (SIB) message or a radio resource control (RRC) message, and
wherein the at least one resource includes a resource by which the terminal is allowed to receive the A2X communication for the A2X service and a resource by which the terminal is allowed to transmit the A2X communication for the A2X service.

15. The base station of claim 13, wherein the at least one resource is dedicated for the A2X service based on the second information, and
wherein the A2X service includes at least one broadcast remote identification (BRID) or detected and avoid (DAA).

16. The base station of claim 13, wherein the controller is further configured to control the transceiver to receive, from the terminal, capability information including information indicating that the A2X service is supported by the terminal.
